(19) United States
(12) Patent Application Publication
(10) Pub. No.: US 2007/0229877 A1
(43) Pub. Date: Oct. 4, 2007

(54) TECHNOLOGY FOR DEALING WITH ERRORS IN PRINTING DEVICE

(75) Inventor: Toshihiro SHIMA, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: Seiko Epson Corporation, Tokyo (JP)

(21) Appl. No.: 11/696,063

(22) Filed: Apr. 3, 2007

(30) Foreign Application Priority Data
Apr. 3, 2006 (JP) 2006101293

(51) Int. Cl. G06K 15/00

(52) U.S. Cl. 358/1.14

(57) ABSTRACT

A printing device configured to print on the basis of a given print job includes an error detector configured to detect an error indicating the possibility that printing of the print job will not be completed under a printing condition that is set for the print job and a printing condition changing section configured to change the printing condition of the print job for completing the printing in a case where the error detector detects an error, wherein the printing condition changing section changes the printing condition of the print job on the basis of the type of the error detected by the error detector and a substitutive printing condition set for the print job corresponding to the type of the error for dealing with the error.

### BACKGROUND

1. Technical Field

The present invention relates to a technology enabling continuous printing by dealing with errors as they occur in a printing device.

2. Related Art

Situations occur in which a printing device is in a status (error status) that printing cannot be continued due to an occurrence of an error such as an “out of paper” error in which all recording paper has been expended. When the printing device is in such an error status, a print job in progress is suspended until the error is dealt with. Moreover, when a print job in progress is suspended, the execution of the following print job is delayed until the process of the current print job is completed after the error status is cleared, although the following print job can be performed in the error status. Thus, the usage efficiency of the printing device is decreased. In order to solve the problem, a method of continuing to print by dealing with errors as they occur by setting a condition for dealing with errors in the printer in advance is proposed (for example, see JP-A-2002-264447).

However, when a condition for avoiding an error is set in the printer, there is a possibility that the result of output is not desirable depending on the type of print job.

### SUMMARY

An advantage of the invention is that it provided a printing device capable of performing continuous printing by dealing with errors as they occur together with improving the output result of each print job.

A printing device according to an aspect of the invention as a printing device configured to print on the basis of a given print job includes an error detector configured to detect an error indicating the possibility that printing of the print job will not be completed under a printing condition that for set in the print job, and a printing condition changing section configured to change the printing condition of the print job for completing the printing in a case where the error detector detects an error. The printing condition changing section changes the printing condition of the print job on the basis of the type of the error detected by the error detector and a substitutive printing condition set for the print job corresponding to the type of the error for dealing with the error.

In this configuration, it becomes possible to resume printing by changing the printing condition set in a print job based on a substitutive printing condition for avoiding an error. In addition, since the substitutive printing condition is configured for the print job, more appropriate printing condition for each operation can be set, and accordingly, the output result of each print job can be made more desirable.

The substitutive printing condition may be set on the basis of data supplied to the printing device at a time when the print job is given to the printing device.

In this case, since the substitutive printing condition is set on the basis of data supplied to the printing device at a time when the print job is given to the printing device, the period in a status that the print is suspended can be shorten.

The printing condition changing section may acquire the substitutive printing condition at a time when the error detected by the error detector is an error in printing and changes the printing condition of the print job on the basis of the substitutive printing condition that has been acquired.

In this case, since the substitutive printing condition can be set on the basis of the detected error, the substitutive printing condition can be set more flexibly.

A plurality of the substitutive printing conditions can be set for each type of error, and the printing condition changing section may be configured to select one of the substitutive printing conditions to be applied for changing the printing condition on the basis of priority levels assigned respectively to the substitutive printing conditions when the plurality of the substitutive printing conditions are set for each type of error.

In this case, since a plurality of the substitutive printing conditions are set, it becomes possible to perform continuous printing by dealing with an error, when the error occurs due to a plurality of reasons. In addition, since the priority levels are assigned respectively to the substitutive printing conditions, an appropriate substitutive printing condition for each job can be used for dealing with the error.

The printing device may perform printing under a printing condition that is set before the printing condition may be changed by the printing condition changing section when the error detected by the error detector is dealt with.

In this case, when the error occurred during performing a print job is cleared, printing is performed under a printing condition closer to an original printing condition, and accordingly, the result of printing after the clearance of the error can be more appropriate for the print job.

The invention may be embodied as various forms. For example, the invention may be embodied as a form such as a printing device and a method of controlling a printing device, computer program for implementing the functions thereof, a recording medium storing the computer program, and a data signal including the computer program which is embodied into carrier waves.

### BRIEF DESCRIPTION OF THE DRAWINGS

The invention will be described with reference to the accompanying drawings, wherein like numbers reference like elements.

FIG. 1 is a schematic diagram showing a configuration of a network system according to a first embodiment of the invention.

FIG. 2 is a schematic diagram showing configurations of a printer and a client.

FIGS. 3A and 3B show an example of the job data transferred from the client to the printer.

FIG. 4 shows information that is stored in substitutive process information storing section when substitutive process configuration information shown in FIG. 3B is analyzed.

FIG. 5 is a flowchart showing a print job receiving routine performed by a print job receiving section.

FIG. 6 is a flowchart showing a print job executing routine performed by a print job executing section.

FIG. 7 is a flowchart showing a print resuming subroutine performed in a step S300 shown in FIG. 6.

FIG. 8 is a schematic diagram showing a property configuration screen setting a print processing condition of a printer.

FIG. 9 shows a detailed configuration screen for setting a substitutive process in a case of “black toner end”.

FIG. 10 is a flowchart of a print resuming subroutine according to a second embodiment of the invention.

FIG. 11 is a schematic diagram showing configurations of a printer and a client according to a third embodiment of the invention.

FIG. 12 is a flowchart of a print job receiving routine according to the third embodiment.

FIG. 13 is a flowchart of a print job executing routine according to the third embodiment.

FIG. 14 is a schematic diagram showing a substitutive process selecting screen that is displayed when a printer monitoring section detects “black toner end”.

FIG. 15 is a flowchart of a print job executing routine according a fourth embodiment.

### DESCRIPTION OF EXEMPLARY EMBODIMENTS

Next, the embodiments of the invention will be described based on examples in the following order.
A. First Embodiment
B. Second Embodiment
C. Third Embodiment
D. Fourth Embodiment
E. Modified Example

### A. First Embodiment

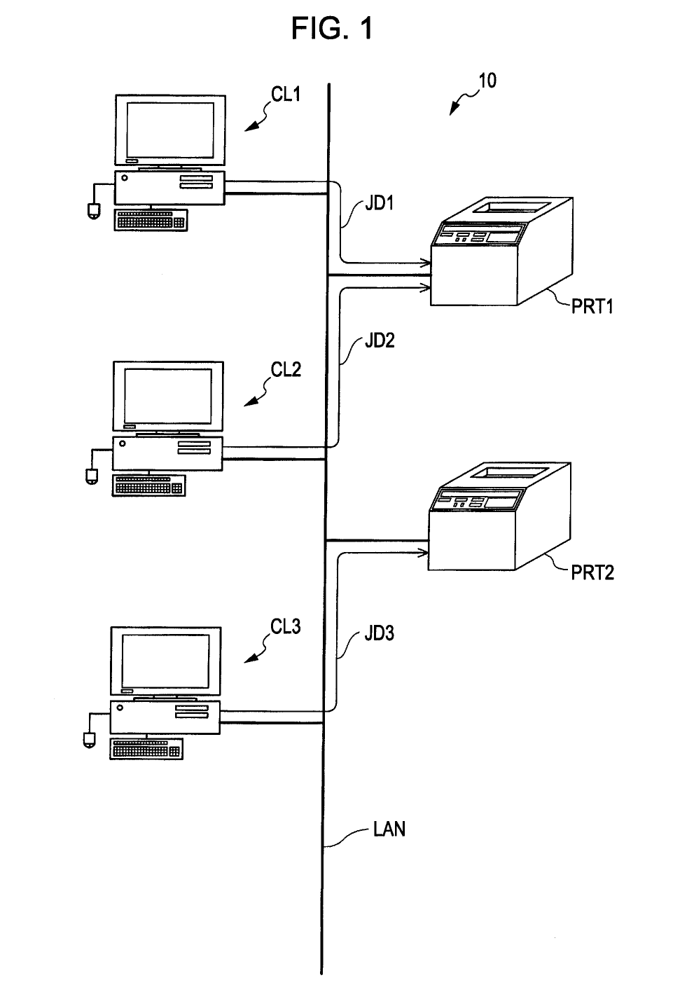

FIG. 1 is a schematic diagram showing a configuration of a network system 10 according to a first embodiment of the present invention. The network system 10 has a configuration in which three clients CL1 to CL3 and two printers PRT1 and PTR2 are connected to each other through a local area network LAN. As the local area network LAN, for example, a wired network defined by IEEE 802.3 or a wireless network such as one defined by IEEE 802.11b/g/a is used.

When users using clients CL1 to CL3 request printing to the printers PRT1 and PRT2, job data (described later) is sent from the clients CL1 to CL3 to the printers PRT1 and PRT2. The job data is communication data based on a network protocol such as TCP/IP sent from the clients CL1 to CL3 to the designated printers PRT1 and PRT2.

When TCP/IP is used for the transfer of job data, the destination of the job data is specified by an IP address. The network protocol used for the transfer of the job data is not limited to TCP/IP, and any network protocol which can be used for transferring job data to a printer through a local area network LAN can be used. For example, a network protocol such as Appletalk (registered trademark) can be used.

In the example shown in FIG. 1, since a user using a first client CL1 requests a printer PRT1 to print, job data JD1 is transferred from the client CL1 to the printer PRT1. Likewise, job data JD2 is transferred from a second client CL2 to the printer PRT1. In addition, job data is transferred from a third client CL3 to a printer PRT2. Accordingly, printing is performed in the printer PRT1 in response to the requests of the users using the first and second clients CL1 and CL2. The second printer PRT2 performs printing in response to the request of the user using the third client CL3.

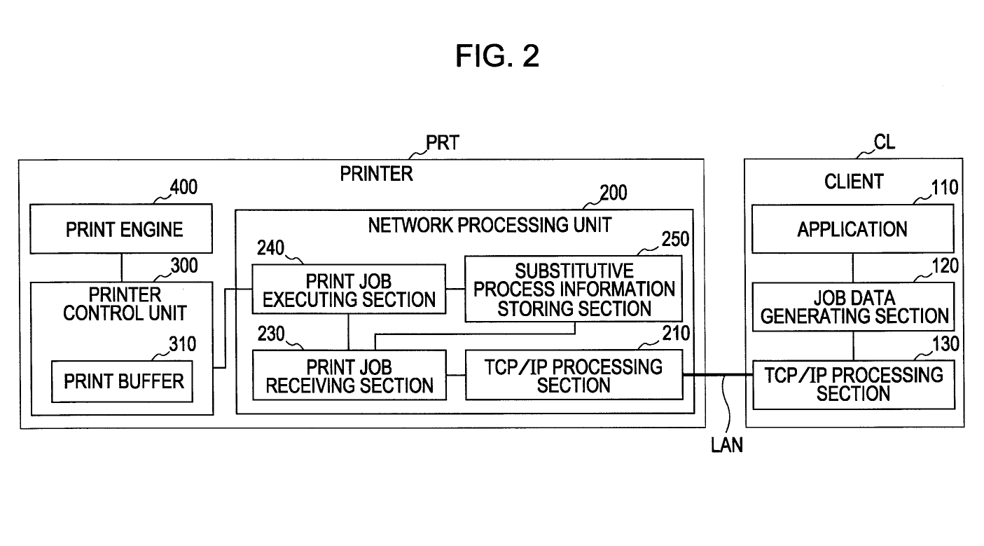

FIG. 2 is a schematic diagram showing configurations of a printer PRT and a client CL. Since the configurations of the three clients CL1 to CL3 shown in FIG. 1 are the same, one client CL as a representative client of the clients CL1 to CL3 is shown in FIG. 2. Likewise, since the configurations of the two printers PRT1 and PRT2 shown in FIG. 1 are the same, one printer PRT as a representative printer of the printers PR1 and PR2 is shown in FIG. 2.

The client CL includes an application 110, a job data generating section 120, and a TCP/IP processing section 130. A client CL being used by a user writes a document for printing by operating the application 110. For printing the written document, the user using the client CL gives a direction for printing a document to the application 110. In accordance with the direction of the user, the application 110 supplies data for printing the document to the job data generating section 120. The job data generating section 120 generates a print command for printing using the printer PRT and supplies job data including the print command to the TCP/IP processing section 130. The TCP/IP processing section 130 sends the job data to the printer PRT through the local area network LAN as communication data based on TCP/IP.

The printer PRT includes a network processing unit 200, a printer control unit 300, and a print engine 400. The network processing unit 200 and the printer control unit 300 respectively include a central processing unit (CPU) and a memory which are not shown in the figure. The print engine 400 is a printing mechanism performing printing based on given data and has a function of performing color printing using toners of four colors including cyan (C), magenta(M), yellow (Y), and black (K) colors. Here, the print engine 400 is not limited to a print engine using four colors for color printing. Thus, the print engine 400, for example, may be a print engine that performs monochrome printing only.

The network processing unit 200 includes a TCP/IP processing section 210, a print job receiving section 230, a print job executing section 240, and a substitutive process information storing section 250. The TCP/IP processing section 210 receives communication data based on TCP/IP supplied from the client CL and supplies the job data included in the communication data to the print job receiving section 230.

The print job receiving section 230 and the print job executing section 240 extract a print command from the job data supplied from the TCP/IP processing section 210. The extracted print command is supplied to a print buffer 310 that is included in the printer control unit 300. The print command supplied to the print buffer 310 is analyzed by the printer control unit 300, and printing used for printing in the print engine 400 is generated. The document written by using the application 110 is printed from the print engine 400 by supplying the generated printing to the print engine 400. Detailed functions of the print job receiving section 230, the print job executing section 240, and the substitutive process information storing section 250 will be described later.

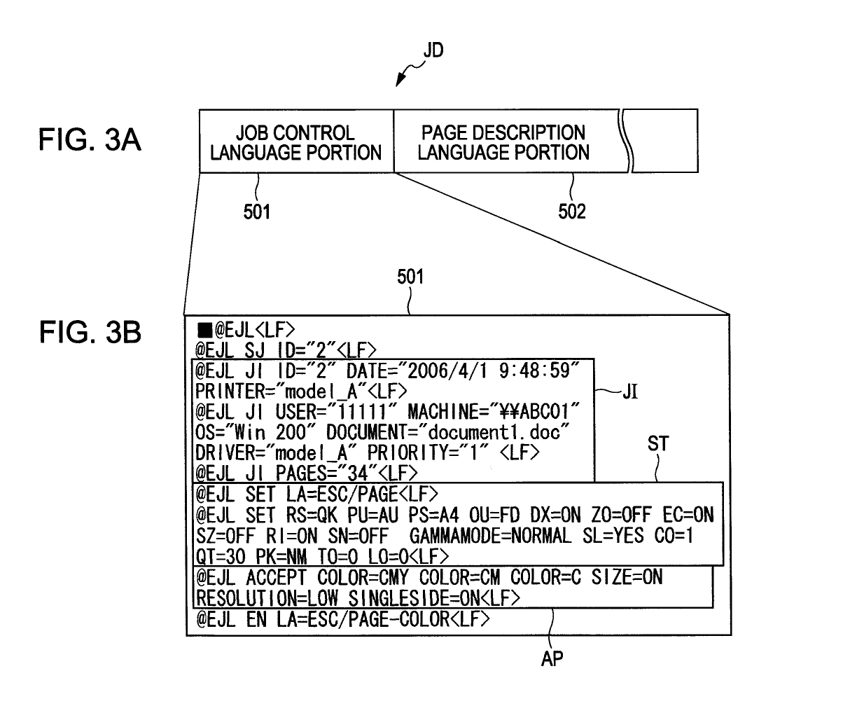

FIGS. 3A and 3B show an example of the job data transferred from the client CL to the printer PRT. The job data JD, as shown in FIG. 3A, includes a job control language portion 501 and a page description language portion 502. The page description language portion 502 is a portion in which a print command indicating the content of a print command is described by using a predetermined page description language. As the page description language, ESC/Page, Postscript, or the like is used. In the job control language portion 501, a configuration for performing printing based on the print command described in the page description language portion 502 is described by using a predetermined job control language.

The print job executing section 240 shown in FIG. 2 analyzes information included in the job control language portion 501 and sets various conditions (print processing condition) for a print process that is performed in the printer control unit 300 on the basis of the result of the analysis. As described above, the print processing condition in the printer control unit 300 is set based on the information included in the job description language portion 501, whereby the output from the print engine 400 (FIG. 2) is performed based on the content of the information included in the job control language portion 501. Since the print processing condition is set for performing printing, it may be referred to as a printing condition.

A detailed example of the content described in the job control language portion 501 is shown in FIG. 3B. The job control language is described by using EJL (Epson Job Language) in the example shown in FIG. 3B. However, as the job control language, for example, XML (extensible Markup Language) or the like other than EJL can be used.

In the job control language portion 501, job information JI, print configuration information ST, and substitutive process configuration information AP are described. In the job information JI, the issue date of a print job (DATE) and the total number of pages (PAGES) represented in a print command in the page description language portion 502, and the like are included. In the print configuration information ST, information for setting a print processing condition such as the printing paper size (PS), the number of sheets for printing (QT), and information indicating the type of the page description language (LA) used for describing the page description language portion 502 are included.

The substitutive configuration information AP indicates a print processing condition which is set in the printer control unit 300 for resuming printing by dealing with an error when the error occurs in the print engine 400 (FIG. 2) or the printer control unit 300. In describing the invention, an error indicates a status that printing cannot be continued under a print processing condition set in advance or a status that there is a possibility of failing to complete the printing under the print processing condition.

The substitutive process configuration information AP is analyzed by the print job receiving section 230 shown in FIG. 2. The result of the analysis is stored in the substitutive process information storing section 250 (FIG. 2). In the example shown in FIG. 3B, four parameters (COLOR, SIZE, LOWRESOLUTION, and SINGLESIDE) and set values for the parameters are described in the substitutive process configuration information AP. In addition, the parameter (COLOR) can take any of three different values so as to represent different colors.

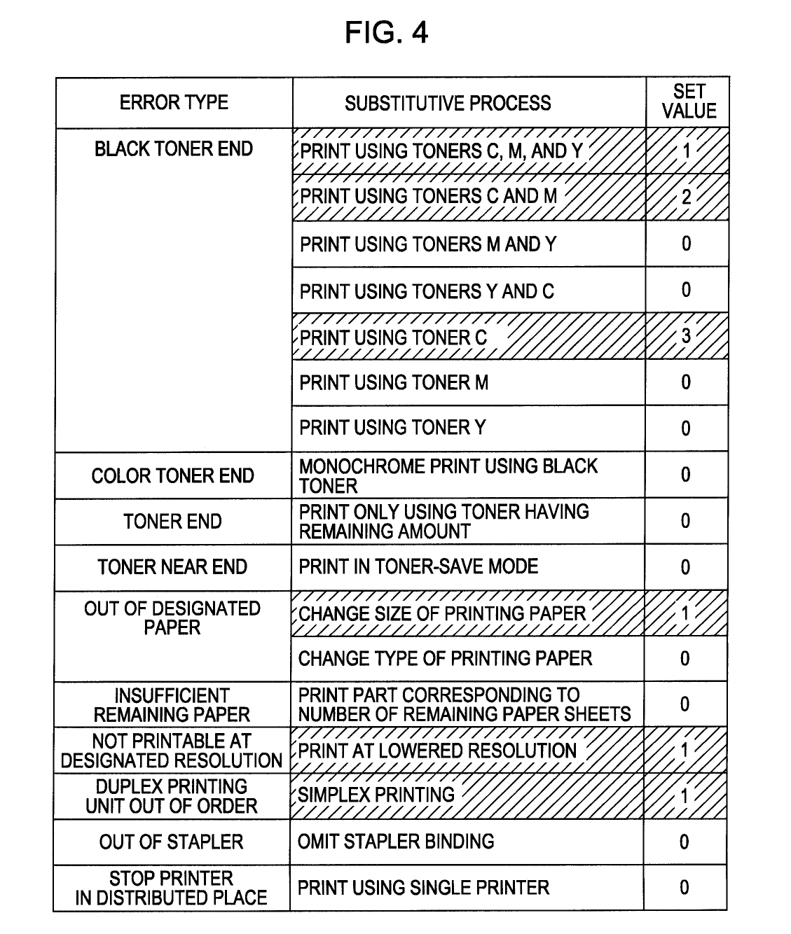

FIG. 4 shows the information (hereinafter, abbreviated as substitutive process information) which is stored in the substitutive process information storing section 250 when the substitutive process configuration information AP shown in FIG. 3B is analyzed. The hatched region in FIG. 4 indicates a part which is configured for the substitutive process to be applied based on the substitutive process information AP shown in FIG. 3B. Hereinafter, to set the configuration for applying the substitutive process is referred to as “to apply a substitutive process”. As shown in FIG. 4, substitutive processes applicable to each error are classified according to the type of errors which can occur in the print engine 400 or the printer control unit 300. The number of substitutive processes is different for each type of error.

The relationship between the types of errors and the substitutive processes is not limited to an example shown in FIG. 4 and is appropriately set according to the characteristics of the printer and the like. The types of the errors may be classified by using a method different from that shown in FIG. 4. Moreover, some of the substitutive processes shown in FIG. 4 may be omitted and/or a substitutive process which is not shown in FIG. 4 may be added. Generally, the combination of the type of error and the substitutive process may be arbitrarily set as long as the substitutive process corresponding to the type of error is predetermined and the printing can be resumed with a corresponding error dealt with by applying the substitutive process.

In the substitutive process information shown in FIG. 4, when the set value is zero, the corresponding substitutive process is not applied. On the other hand, when the set value is not zero, a substitutive process is applied when an error corresponding to the substitutive process occurs. When there are a plurality of substitutive processes which are applicable to one type of error, values indicating priority levels of the substitutive processes are stored as set values. Alternatively, priority levels may not be assigned to the substitutive processes. In this case, for the type of an error having a plurality of applicable substitutive processes, for example, it is described only whether the substitutive process will be applied in the substitutive process configuration information AP (FIG. 3B), and a substitutive process is selected based on a default priority level.

In the example shown in FIG. 3B, it is described that printing using a color toner is permitted (COLOR) when the black toner runs out during monochrome printing. In the substitutive process configuration information AP of the first embodiment, the priority levels decrease as the substitutive process is described in the latter part. Accordingly, as the substitutive process for “black toner end”, printing using cyan (C), magenta (M), and yellow (Y) toners has the highest priority level as shown in FIG. 4. When there is not remaining yellow toner (Y), since the printing using CMY toners cannot be performed, printing using CM toners which has the next priority level is substituted. When there is not the magenta (M) toner, printing using the cyan (C) toner is substituted.

In the example shown in FIG. 4, as types of errors which can occur during color printing, two errors including “a color toner end” in which one of CMY toners is not left and “a toner end” in which one of CMYK toners is not left are shown. When one of CMY toners is not left, one between a substitutive process in which monochrome printing is performed and a substitutive process in which printing is performed using only toners having remaining amounts is selected as the substitutive process to be applied.

As shown in FIG. 4, as a substitutive process in a case where the remaining amount of any of CMYK toners reaches a predetermined minimal value (“toner near end”), a substitutive process in which printing is performed in a toner save mode (also referred to as a draft printing mode) decreasing the amount of toner consumption can be set.

When the designated paper is not left, printing using paper other than the designated paper is performed in a substitutive process. When the designated paper is not left, as shown in FIG. 4, a substitutive process for changing the size of print paper (for example, from A3 to A4) and a substitutive process for changing the type of the designated printing paper (for example, from color paper to white paper) may be set. When the remaining designated paper is not sufficient, a partial printing in which printing is performed using the remaining designated paper up to a printable range may be set.

In the example of FIG. 4, as a substitutive process for a case where a high resolution (for example, 600 dpi) printing cannot be performed due to a limitation on the size of the memory capacity included in the printer control unit 300 (FIG. 2) or the like, a substitutive process in which low resolution (for example, 300 dpi) printing is performed may be set. When a duplex printing unit for performing duplex printing is out of order, a substitutive process in which simplex printing instead of duplex printing is performed may be set.

When the printer PRT (FIG. 2) has a function of automatically performing stapler binding and the stapler is not left, a substitutive process for omitting the stapler binding can be set. When the printer PRT is configured to have a function of distributed printing in which a received print job can be distributed to other printers and a printer in a distributed location of the print job is stopped (printer in the distributed location is stopped), a process of not distributing the print job and printing using only the printer PRT may be set as the substitutive process.

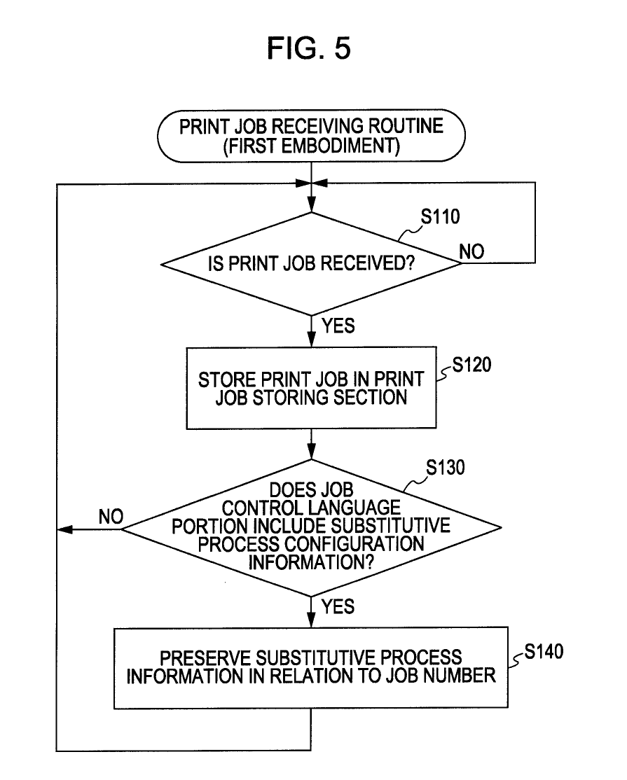

FIG. 5 is a flowchart showing a print job receiving routine performed by the print job receiving section 230 (FIG. 2). The print job receiving routine shown in FIG. 5 is started when the operation of the printer PRT is started.

In a step S110, the print job receiving section 230 determines whether a print job is received from the client CL. When the print job is received, the control is moved to a step S120. On the other hand, when the print job is not received, the control is moved back to repeat the step S110 until the print job is received.

In a step S120, the print job receiving section 230 assigns a job number that is used for specifying a print job and registers the job number in a job queue (not shown). The job number is a serial number that is sequentially increased based on the order of reception of a print job. The job data is stored in a print job storing section (not shown) which is a part of memory included in the printer PRT in relation to the assigned job number. In the first embodiment, the printer PRT is configured to have the print job storing section, but the print job storing section may be provided to any other network device connected to a local area network LAN.

In a step S130, the print job receiving section 230 determines whether substitutive process configuration information AP (FIG. 3B) is included in the job control language portion 501 (FIG. 3A). When the substitutive process configuration information AP is determined to be included, the control is moved to a step S140. On the other hand, when the substitutive process configuration information AP is determined to be not included, the control is moved back to the step S110, and the print job receiving section 230 is in a status waiting for receiving a print job.

In a step S140, the print job receiving section 230 generates substitutive process information (FIG. 4) by analyzing the description of the substitutive process configuration information AP of the job control language portion 501. Then, the generated substitutive process information is stored in the substitutive process information storing section 250 (FIG. 2) in relation to the job number. After the storage of the substitutive process information, the control is moved back to the step S110, and the print job receiving section 230 is in a status waiting for receiving a print job.

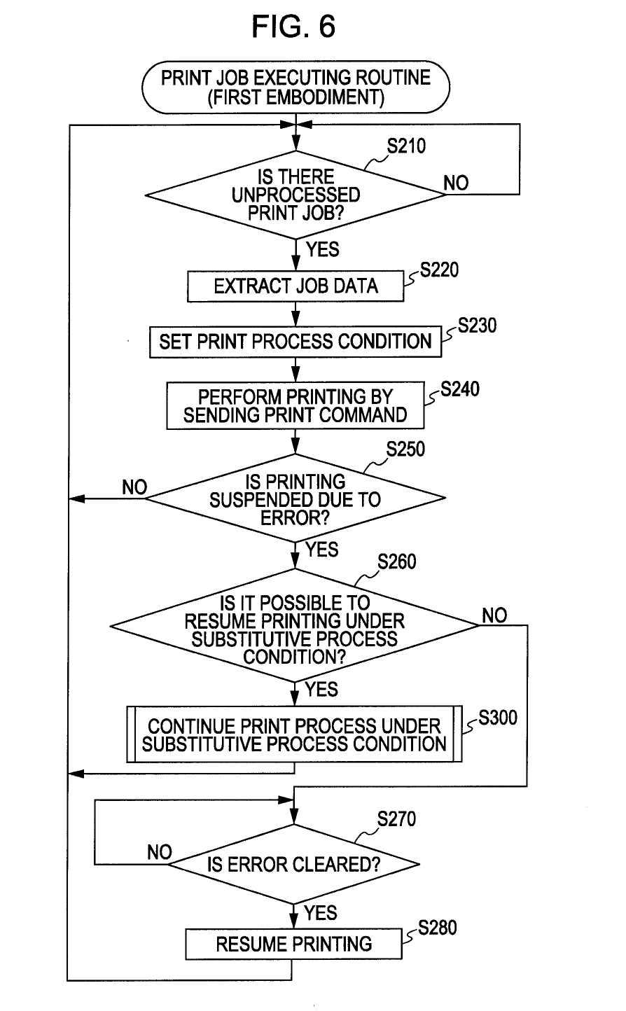

FIG. 6 is a flowchart showing a print job executing routine performed by the print job executing section 240 (FIG. 2). The print job executing routine is started when the operation of the printer PRT is started, like the print job receiving routine shown in FIG. 5.

In a step S210, the print job executing section 240 determines whether there is any un-processed print job. The determination on whether there is any un-processed print job can be performed by checking whether a job number is registered in the job queue. When there is an un-processed print job, the control is moved to a step S220. On the other hand, when there is not an un-processed print job, the control is moved back to repeat the step S210.

In a step S220, the job data stored in the print job storing section is extracted in relation to the unprocessed job number. Thereafter, in a step S230, the print job executing section 240 sets a print processing condition which is acquired by analyzing the description of the job control language portion 501 (FIGS. 3A and 3B) included in the extracted job data on the printer control unit 300 (FIG. 2).

In a step S240, the print job executing section 240 extracts a print command registered in the page description language portion 502 from the job data and transfers the print command to the printer control unit 300. The printing generated by the printer control unit 300 is supplied to the print engine 400 by the transfer of the print command, so that printing is performed. When printing is completed or printing is suspended due to the occurrence of an error, the control is moved to a step S250.

In the step S250, the print job executing section 240 determines whether printing is suspended due to the occurrence of an error. The occurrence of the error can be determined by the print job executing section's 240 acquiring information indicating an error status from the printer control unit 300. When an error occurs, the control is moved to the step S250. On the other hand, when printing is completed without any error, the control is moved back to the step S210.

In a step S260, the print job executing section 240 determines whether printing of the print job in execution can be resumed by dealing with the error on the basis of the substitutive process information (FIG. 4) which is stored in the substitutive process information storing section 250 in relation to the job number. To be more specifically, it is determined that the printing can be resumed when a substitutive process applicable to the occurred type of the error is set. When it is determined that the printing can be resumed, the control is moved to a step S300. On the other hand, when it is determined that the printing cannot be resumed, the control is moved to a step S270.

In the step S270, it is determined whether the error is cleared, and the step S270 is repeated until the error is cleared. When the error is cleared, in a step S280, the print job executing section 240 transfers a direction for resuming the printing to the printer control unit 300 to resume the suspended printing.

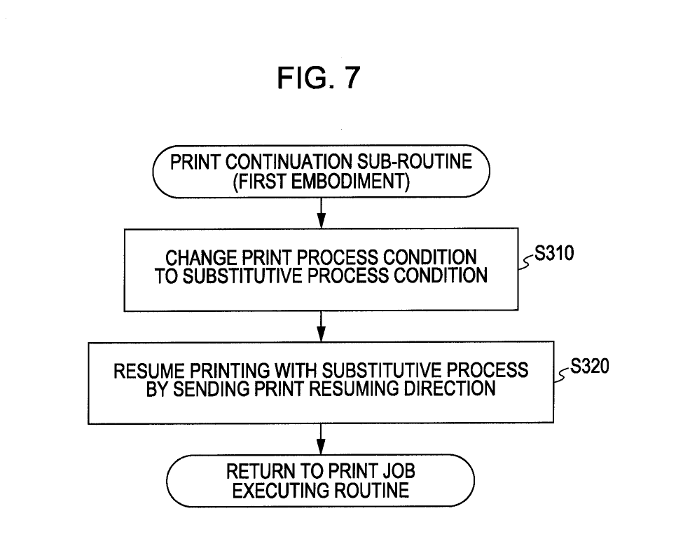

FIG. 7 is a flowchart showing a print resuming subroutine performed in the step S300 shown in FIG. 6. In a step S310, the print job executing section 240 replaces the print processing condition with a substitutive process condition on the basis of the type of the occurred error and the substitutive process information (FIG. 4) stored in the substitutive process information storing section 250. To be more specifically, the print job executing section 240 selects a substitutive process for the occurred error from the substitutive process information stored in the substitutive process information storing section 250. Thereafter, the print job executing section 240 transfers a direction for replacing the print processing condition to the printer control unit 300, so that the printing process is performed under the selected substitutive process. In a step S320 after replacing the print processing condition in the step S310, the print job executing section 240 transfers a direction for resuming the printing to the printer control unit 300, so that the printing based on the substitutive process is resumed.

As can be understood from the description above, the print job executing section 240 serves as both an error detecting section for detecting the occurrence of an error and a printing condition changing section for changing the print processing condition (printing condition). Since the substitutive process information is a condition for changing the printing condition, the substitutive process information may be regarded as a changing printing condition for changing the printing condition.

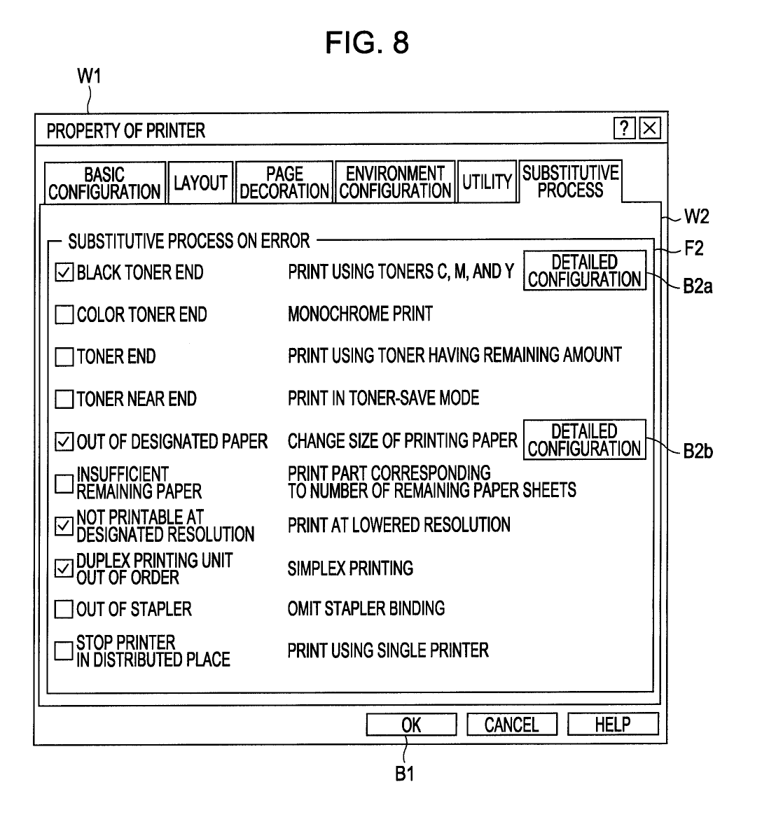

FIG. 8 shows an appearance of setting the substitutive process in the client CL (FIG. 2). In the first embodiment, the substitutive process is set by transferring job data including the substitutive process configuration information AP from the client CL to the printer PRT (FIG. 2). Accordingly, whether the substitutive process is applied in the printer PRT is set before a user using the client CL gives a printing direction to the application 110 (FIG. 2).

When a user performs an operation for setting the print processing condition of the printer in the client CL, a property configuration screen W1 shown in FIG. 8 is displayed in the client CL. A plurality of tabs for setting various print processing conditions for printing are arranged in the property configuration screen W1. Various set screens such as basic configuration, layout, and substitutive process are displayed according to the user's tab selection. In addition, various buttons such as OK button B1 is provided in the property configuration screen W1.

In FIG. 8, since the substitute process tab among the plurality of tabs in the property configuration screen W1 is selected, the substitutive process configuration screen W2 is displayed on the property configuration screen W1. A substitutive process configuration field F2 for the occurrence of an error and two detailed configuration buttons B2a and B2b are provided on the substitutive process configuration screen W2. In the substitutive process configuration field F2 for the occurrence of an error, the types of errors corresponding to items of the substitutive process information (FIG. 4) and substitutive processes applied for each type of the error are displayed. To the left side of the type of the error, check boxes corresponding to the types of errors are provided. By giving a check mark in the check box, a substitutive process corresponding to each type of the error is set.

For the types of errors (“black toner end” and “out of designated paper”) for which a plurality of substitutive processes can be applied, the detailed configuration buttons B2a and B2b are respectively arranged in the right end of the configuration field F2. When the user clicks the button B2a or B2b, a detailed configuration screen for designating a substitutive process among a plurality of substitutive processes is displayed in the client CL.

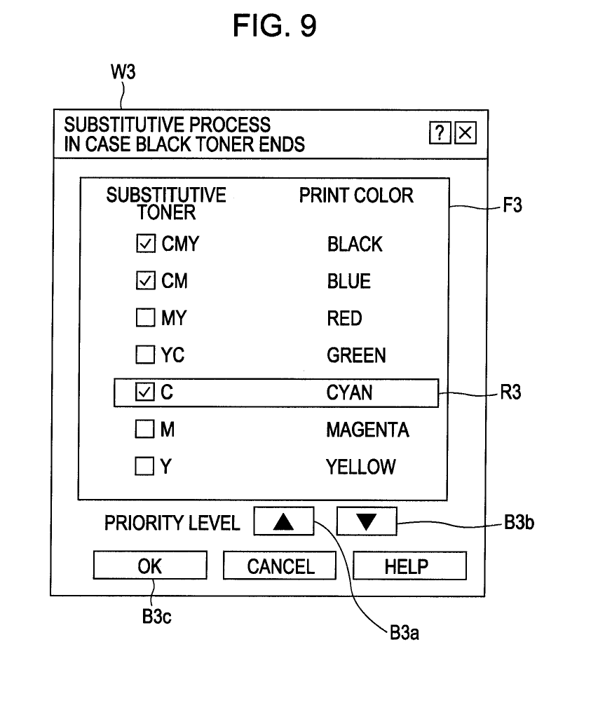

In FIG. 9, a detailed configuration screen W3 for setting a substitutive process in a case of “black toner end” is shown. The detailed configuration screen W3 is displayed in the client CL when the user clicks the detailed configuration button B2a which is provided for “black toner end” shown in FIG. 8. Various buttons such as a configuration field F3 which sets a substitutive process among the plurality of substitutive processes to be applied, two buttons B3a and B3b which changes priority levels, and an “OK” button B3c are provided in the detailed configuration screen W3.

In the configuration field F3, toners (substitutive toners) used instead of a black toner and colors (print colors) which are respectively printed when the substitutive toners are used for printing are shown. Check boxes corresponding to the substitutive toners are provided to the left side of the substitutive toner display. By giving a check mark in the check boxes, a substitutive process in which substitutive toners are used instead of a black toner for printing is set.

The user can select a specific substitutive toner by clicking a region in which the name of a specific substitutive toner is displayed in the configuration field F3. In the example shown FIG. 9, the cyan (C) toner is selected, and thus a region R3 in which “C toner” is displayed as the name of the substitutive toner is inverted. When the user clicks the button B3a for increasing the priority level, the display of the selected substitutive toner is sequentially moved up, and accordingly, the priority level of the substitutive process using the selected substitutive toner is increased. On the other hand, when the user clicks the button B3b for lowering the priority level, the display of the selected substitutive toner is sequentially moved down, and accordingly, the priority level of the substitutive process using the selected substitutive toner is lowered.

When the user clicks the “OK” button B3c after setting the substitutive process in a case of “black toner end” as described above, the detailed configuration screen W3 is closed, and the property configuration screen W1 shown in FIG. 8 is displayed in the client CL. When the user clicks the “OK” button B1 provided in the property configuration screen W1, the configuration of the substitutive process is stored in memory of the client CL which is not shown.

When printing a document in accordance with a user's printing direction, the job data generating section 120 (FIG. 2) of the client CL generates the substitutive process configuration information AP (FIG. 3B) based on the configuration of the substitutive process which is stored in the memory of the client CL. The job data including the generated substitutive process configuration information AP is transferred to the printer, whereby setting the substitutive process for a print job of the printer PRT corresponding to the job data is performed.

As described above, in the first embodiment, when printing is suspended due to the occurrence of an error, the print processing condition is changed to the substitutive process condition, and the printing is resumed after the change in the print processing condition. By setting the substitutive process condition to resume printing, it becomes possible to resume the printing suspended due to the occurrence of the error by dealing with the error that has caused the suspension of the printing.

In the first embodiment, the substitutive process configuration information AP for setting a substitutive process is included in the job data which is transferred from the client CL to the printer PRT. Accordingly, the printer PRT can set the substitutive process which is applied in a case of the occurrence of the error for each print job. Thus, when an error occurs, the printing is resumed based on the substitutive process set for each print job, and accordingly, the process for the occurrence of the error which is appropriate for the print job can be performed.

### B. Second Embodiment

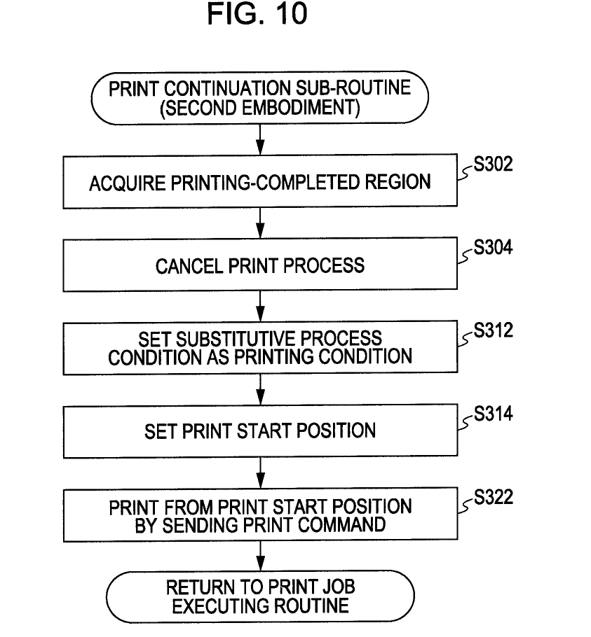

FIG. 10 is a flowchart of a print resuming subroutine according to a second embodiment of the invention. In the second embodiment, a print resuming subroutine executed in the step S300 of the print job executing routine shown in FIG. 6 is different from the subroutine shown in FIG. 7 in the first embodiment. Other operations of the second embodiment are the same as those of the first embodiment.

In a step S302, the print job executing section 240 (FIG. 2) acquires a range (printing completed region) of a print job for which printing is completed from the printer control unit 300 (FIG. 2). To be more specifically, the number of times of printing and the page number of the printed page of the print job at a time when printing is suspended due to the occurrence of the error are acquired. Thereafter, in a step S304, the print job executing section 240 supplies a direction for cancelling the printing process to the printer control unit 300.

In a step S304, the print job executing section 240 extracts job data corresponding to the print job currently in execution from the print job storing section with reference to a job number of the print job in execution.

In a step S312, the print job executing section 240 acquires a print processing condition by analyzing the description of the job control language portion 501 included in the extracted job data. The print job executing section 240 changes the print processing condition to the substitutive processing condition by applying a substitutive process of the print processing condition designated by the job data based on an occurred error. Thereafter, the print job executing section 240 sets the print processing condition after the change to the printer control unit 300.

In a step S314, the print job executing section 240 sets the print start position. To be more specifically, the print job executing section 240 acquires job data (FIGS. 3A and 3B) from the print job storing section and extracts the number of times of printing M (QT) and the total number of pages N (PAGES). The print job executing section 240 calculates the print start position based on the extracted number of times of printing M, total number of pages N, and the printing completed range acquired in the step S302 and sets the print start position to the printer control unit 300.

When the completed printing range acquired in the step S302 is page n0 of the m0-th times of printing, the print start position (page n1 of m1-th times of printing), for example, can be acquired by using the following equations.

if n0=N:m1=m0+1, n1=1 1.

if n0≠N:m1=m0, n1=n0+1 2.

In a step S322, the print job executing section 240 extracts a print command registered in the page description language portion 502 from the job data and transfers the print command to the printer control unit 300. In accordance with the transfer of the print command, printing from the print start position set in the step S314 under the print processing condition set in the step S312 is performed.

As described above, in the second embodiment, when printing is suspended due to the occurrence of an error, the completed printing range before the suspension of the printing is acquired and the substitutive processing condition is set. Thereafter, printing from the print start position of the next page is performed. As in the first embodiment, by printing from the print start position after setting the substitutive processing condition, the printing suspended due to the occurrence of an error can be resumed with the error having caused the suspension of the printing dealt with.

In the second embodiment, like in the first embodiment, the printer PRT can set the substitutive process which is applied on the occurrence of the error for each print job. Accordingly, the process on the occurrence of an error can be made appropriate for each print job.

In addition, the second embodiment, is more preferable than the first embodiment in that for a case where the print processing condition cannot be changed at a time other than the start of printing, resuming printing can be performed in accordance with the substitutive processing condition. On the other hand, the first embodiment is more preferable than the second embodiment in that the required capacity of the print job storing section can be reduced since the job data can be removed from the print job storing section after performing the printing.

### C. Third Embodiment

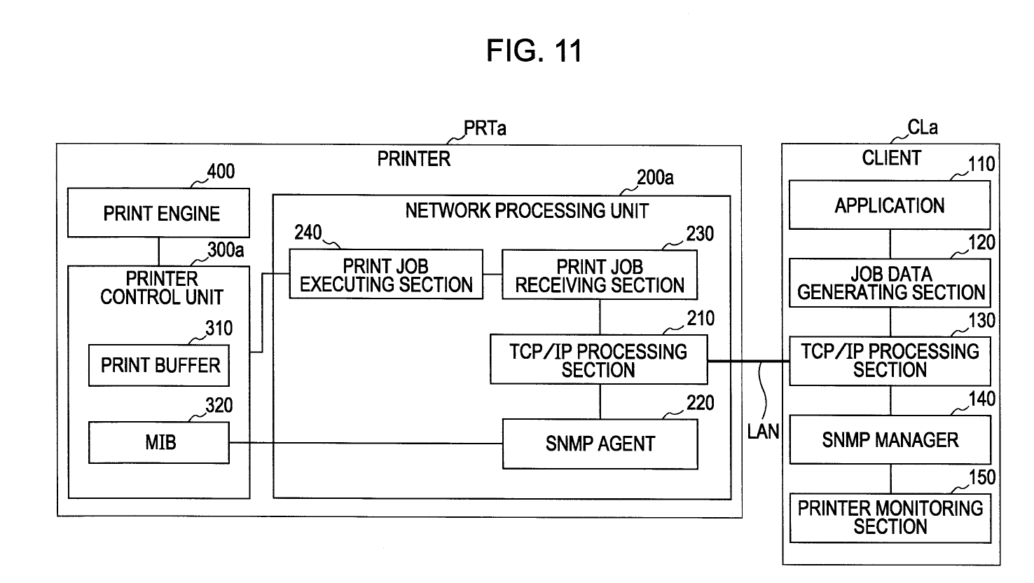

FIG. 11 is a schematic diagram showing configurations of a printer PRTa and a client CLa according to a third embodiment. There are differences between the first and third embodiments in that the job data (FIG. 3A) does not include the substitutive process configuration information AP and the substitutive process is designated at a time when an error occurs in the third embodiment. Other configurations of the third embodiment are the same as the first embodiment.

The client CLa of the third embodiment shown in FIG. 11 is different from the client CL of the first embodiment shown in FIG. 2 in that an SNMP manager 140 and a printer monitoring section 150 are added. In addition, the configurations of a network processing unit 200a and a printer control unit 300a of the printer PRTa of the third embodiment shown in FIG. 11 are different from the printer PRT of the first embodiment shown in FIG. 2. The network processing unit 200a of the third embodiment is different from the network processing unit 200 of the first embodiment in that an SNMP agent 220 is added and the substitutive process information storing section 250 is omitted. The printer control unit 300a of the third embodiment is different from the network control section 300 of the first embodiment in that an MIB 320 is added. Other configurations of the third embodiment are the same as the first embodiment.

The SNMP manager 140 has a function of sending/receiving a message based on an SNMP (Simple Network Management Protocol) to/from the SNMP agent 220. The message transfer between the SNMP manager 140 and the SNMP agent 220 is performed through the TCP/IP processing section 130, the TCP/IP processing section 210, and the local area network LAN.

The SNMP manager 140 sends a message (send request message) requesting for sending predetermined information to the SNMP agent 220. The SNMP agent 220 which has received the send request message accesses an MIB (Management Information Base) 320 included in the printer control unit 300a to send a message (response message) including information stored in MIB 320 to the SNMP manager 140. The SNMP manager 140 sends a message (storage request message) requesting for storing predetermined information to the SNMP agent 220. The SNMP agent 220 which has received the storage request message accesses MIB 320 to store the predetermined information included in the storage request message in MIB 320. MIB 320 is a kind of a database storing information indicating the status of the printer PRTa and the like.

By the transfer of a message between the SNMP manager 140 and the SNMP agent 220, the printer monitoring section 150 which is provided to the client CLa can acquire predetermined information from the printer control unit 300a or store the predetermined information in the printer control unit 300a. However, any protocol other than SNMP can be used as long as the transfer of a message between the printer PRTa and the client CLa can be performed.

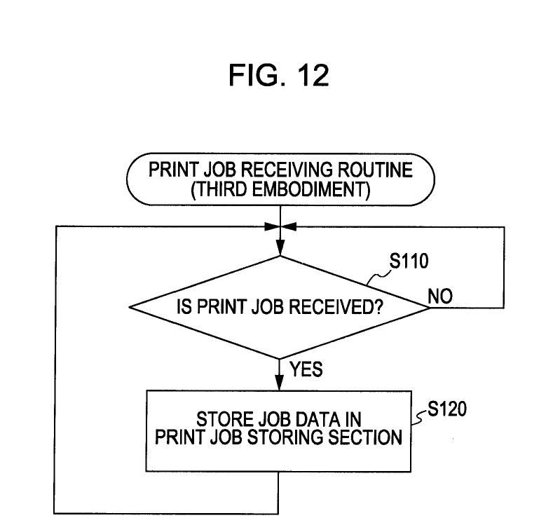

FIG. 12 is a flowchart of a print job receiving routine according to the third embodiment. The print job receiving routine of the third embodiment is different from that of the first embodiment shown in FIG. 5 in that two steps S130 and S140 for handling/processing the substitutive process information configuration information AP included in the job data (FIG. 4) are omitted. Other operations of the third embodiment are the same as the first embodiment.

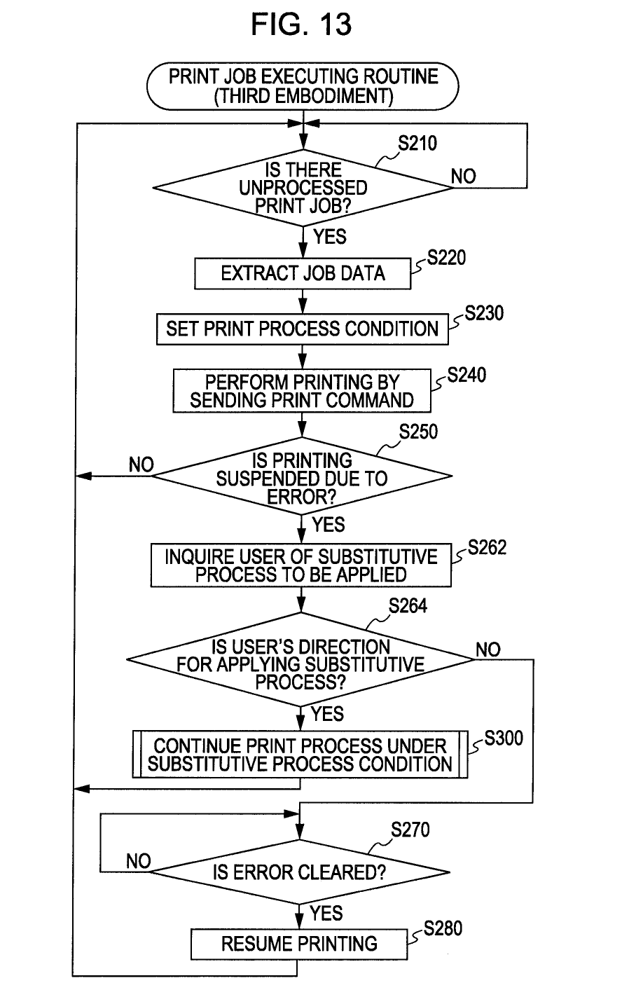

FIG. 13 is a flowchart of a print job executing routine according to the third embodiment. The print job executing routine of the third embodiment shown in FIG. 13 is different from that of the first embodiment shown in FIG. 6 in that the step S260 is replaced with two steps S262 and S264. Other operations of the third embodiment are the same as those of the first embodiment.

In a step S262, a print job executing section 240 (FIG. 11) inquires the user of a substitutive process to be applied for resuming the printing. To be more specifically, the print job executing section 240 stores error type information which indicates the type of an error in MIB 320 of the printer control unit 300a in relation to a job number. The printer monitoring section 150 of the client CLa regularly acquires the error type information through the SNMP manager 140 and the SNMP agent 220 to detect the occurrence of an error.

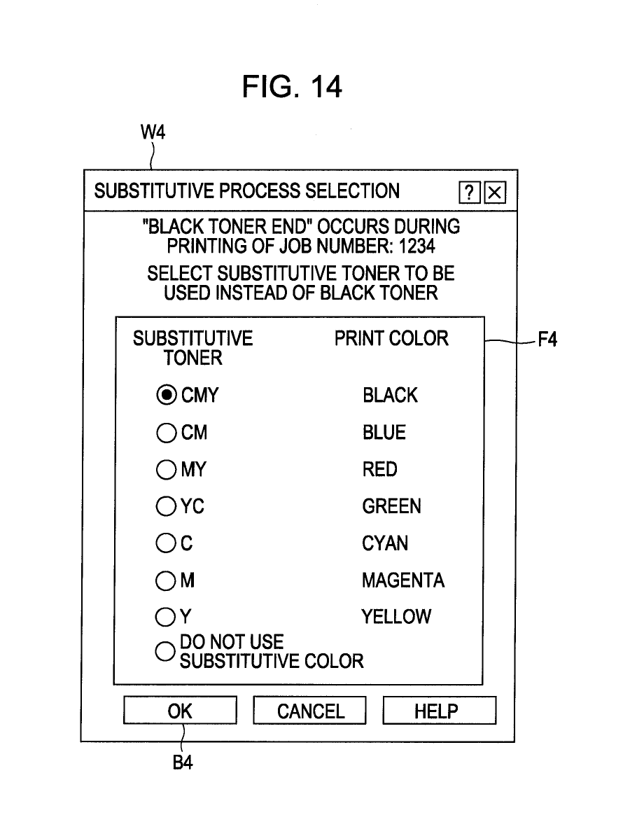

FIG. 14 is a schematic diagram showing a substitutive process selecting screen W4 which is displayed in the client CLa when the printer monitoring section 150 detects “black toner end”. In the substitutive process selecting screen W4, a selection field F4 allowing the user to select a substitutive process is displayed together with a job number of the print job for which an error occurs. However, the substitutive process selecting screen which is displayed in the client CLa on the occurrence of an error is changed appropriately based on the type of the error or the content of the substitutive process.

In the selection field F4, substitutive toners used instead of a black toner and the print color in a case where each substitutive toner is used for printing are displayed. In the left side of the display of the substitutive toners, radio boxes are respectively provided in response to substitutive toners. In addition, in the selection field F4, a character string “substitutive toner is not used” indicating that not using the substitutive toner can be selectable is displayed. To the left side of the character string, a radio box is provided similarly for the substitutive toner. The user can click the radio boxes to give a mark in one of the radio boxes.

When the user clicks the “OK” button after selecting the substitutive process, the substitutive process selecting information corresponding to the marked radio box is stored in MIB 320 of the printer PRTa from the printer monitoring section 150. In the step S262 of FIG. 13, the print job executing section 240 acquires the user's direction for the substitutive process to be applied from the substitutive process selecting information stored in MIB 320.

In a step S264, the print job executing section 240 determines whether the user's direction is for applying a substitutive process. When the user's direction is for applying a substitutive process, the control is moved to the step S300. On the other hand, when the user's direction is for not applying a substitutive process, the control is moved to the step S270. In the step S300, since the print processing condition (printing condition) is changed based on the substitutive process selecting information, the substitutive process selecting information may be also regarded as a changing printing condition which changes the printing condition.

As described above, also in the third embodiment, the substitutive process to be applied is inquired of the user and the substitutive process is applied in accordance with the user's direction. Accordingly, it becomes possible to resume the printing which has been suspended due to the occurrence of the error by dealing with the error caused the suspension of the print. In addition, a substitutive process to be applied on the occurrence of the error can be selected for each print job. Accordingly, the process on the occurrence of an error can be made appropriate for the print job.

In the third embodiment, the print job executing section 240 (FIG. 11) inquires the substitutive process to be applied (step S262), determines whether the user's direction is for applying the substitutive process (step S264), and resuming the printing process in accordance with the substitutive processing condition (step S300). However, the above-described processes may be performed by the printer monitoring section 150 of the client CLa. In this case, the printer monitoring section 150 stores information for setting the substitutive process to be applied and information directing to resume the printing in MIB 320 of the printer PRTa, so that the printing can be resumed with the substitutive process applied. In this case, the SNMP manager 140 of the client CLa and the printer monitoring section 150 correspond to a part of the printing device according to an embodiment of the invention.

In the third embodiment, the print job executing section 240 (FIG. 11) sets the substitutive process based on the substitutive process selecting information transferred to MIB 320 from the printer monitoring section 150. However, the setting of the substitutive process may be performed by using a different method. For example, the printer monitoring section 150 may send data including the substitutive process configuration information AP (FIG. 3B) based on the user's direction and the job number for which the substitutive process is set to the print job receiving section 230 (FIG. 11), whereby the substitutive process is set.

In the third embodiment, the print job executing section 240 inquires the substitutive process to be applied of the user using the client CLa. However, the acquiring method of the substitutive process is not limited thereto, and a method in which the information designating the substitutive process can be acquired on the occurrence of the error may be used. For example, the print job executing section 240 may inquire the substitutive process to be applied of a user using an administration computer that manages the printer PRTa or a user using a computer connected to the printer PRTa through a USB (Universal Serial Bus) or the like. Alternatively, a message inquiring the substitutive process is displayed in a display section of the printer PRTa which is not shown in the figure, and the information designating the substitutive process based on the input from the operating section is acquired from the input of an operation section (not shown).

### D. Fourth Embodiment

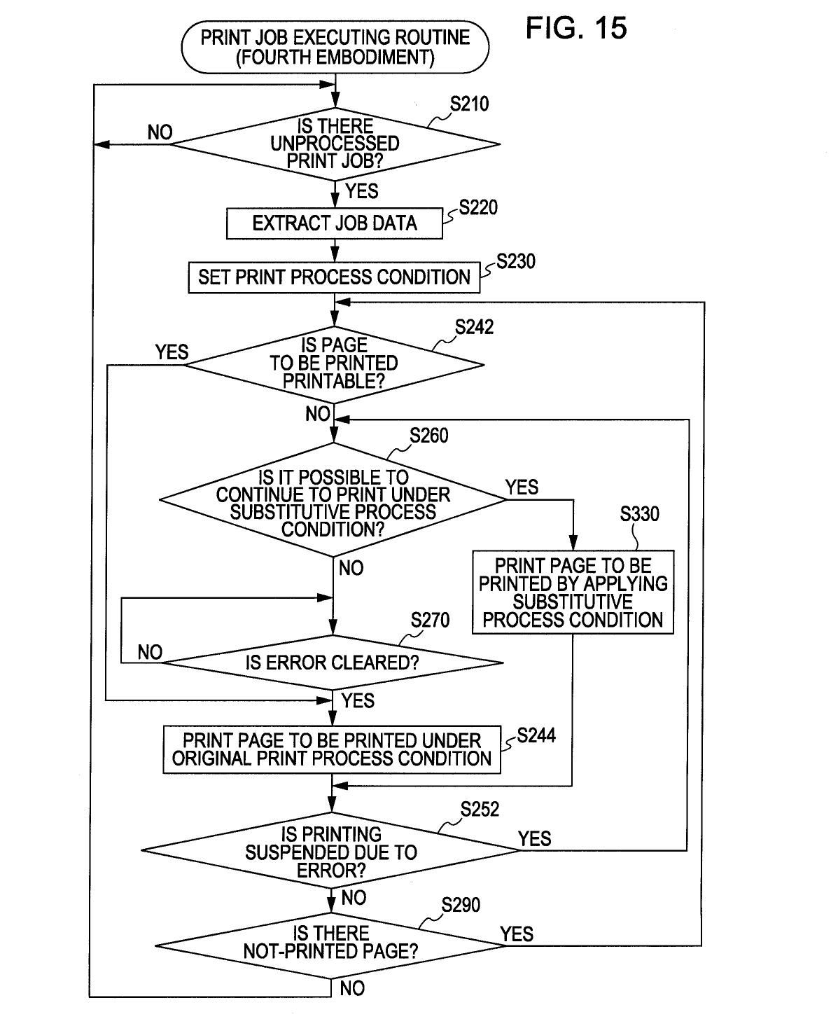

FIG. 15 is a flowchart of a print job executing routine according a fourth embodiment. The fourth embodiment is different from the first embodiment in that the occurrence of an error is detected for each page of the print job and the printing is performed in accordance with a substitutive process condition for each page. Other operations are the same as those of the first embodiment. The print job executing routine shown in FIG. 15 is different from that shown in FIG. 6 in that the steps S240 to S280 are replaced with the steps S242 to S290. Since the steps S260 and S270 are the same as those of the print job executing routine shown in FIG. 6, the description thereof is omitted.

In the step S242, the print job executing part 240 determines whether one page (printing target page) of not-printed pages of the print job can be printed. To be more specifically, the print job executing part 240 acquires information indicating an error status from the printer control unit 300. When the acquired information indicates an error status, it is determined that the printing of the printing target page cannot be performed, and the control is moved to the step S260. On the other hand, when the acquired information does not indicate an error status, it is determined that the printing of the printing target page can be performed, and the control is moved to the step S244. However, the print job executing part 240 may determine that the printing target page can be printed when the error such as “toner near end”, “insufficient remaining paper”, or the like for which the print can be resumed under a print processing condition set in advance occurs.

In the step S244, the print job executing section 240 performs printing for the printing target page in accordance with a print processing condition set originally to the print job. To be more specifically, the print job executing section 240 extracts a print command corresponding to the printing-target pages stored in the page description language portion 502 of the job data JD (FIG. 3A). The print job executing section 240 supplies the extracted print command to the printer control unit 300, whereby the printing for the printing-target page is performed.

In the step S330, the print job executing section 240 performs printing for the printing-target page with the substitutive process applied. The print job executing section 240 changes the print processing condition to the substitutive process condition and then, supplies a print command corresponding to the printing-target pages stored in the page description language portion 502 to the printer control unit 300. After the supply of the print command to the printer control unit 300, the printing condition is changed back to the original print processing condition described in the job control language portion 501.

In the step S252, as in the step S250 (FIG. 6), the print job executing section 240 determines whether the printing for the printing-target page is suspended due to an error. When the printing for the printing-target page is suspended, the control is moved to the step S260. On the other hand, when the printing for the printing-target page is completed, the control is moved to the step S290.

In the step S290, the print job executing section 240 determines whether there is a not-printed page in the print job. The determination on whether there is a not-printed page can be made by determining whether all the print commands stored in the page description language portion 502 are sent to the printer control unit 300. When it is determined that there is a not-printed page, the control is moved back to the step S242. On the other hand, when it is determined that there is not a not-printed page, since the printing for the print job is completed, the control is moved back to the step S210.

As described above, in the fourth embodiment, when an error occurs, the printing-target page is printed in accordance with a substitutive process condition, it becomes possible to resume the printing with the error dealt with. In addition, in the fourth embodiment, it is determined whether an error occurs for each page of the print job. Accordingly, when the error is cleared during the execution of the print job, the printing after the clearance of the error is performed in accordance with the original print processing condition of the print job, and thus the result of the printing for each page after the clearance of the error can be more desirable which is more appropriate for the print job.

The fourth embodiment is more preferable than the first embodiment in that the result of the printing after the clearance of the error can be improved. On the other hand, the first embodiment is more preferable than the fourth embodiment in that the control can be performed more easily by the print job executing part 240.

In the fourth embodiment, the execution of printing and detection of an error are performed for each page of the print job, but the execution of printing and detection of an error may be performed in different units for printing. For example, the execution of printing and detection of an error may be performed for each predetermined lines or for each predetermined pages. In this case, since it is determined whether an error occurs for each unit for printing, the result of the printing in the units after the clearance of the error can be made more appropriate and desirable for the print job.

### E. Modified Example

The present invention is not limited to the above-described examples and embodiments and may be performed in various forms without departing the gist of the invention, and the following modifications can be made.

### E1. Modified Example 1

In the first to third embodiments, when printing is suspended due to the occurrence of an error, the printing is resumed by applying a substitutive process. However, the error may be detected before printing, and when an error is detected, the print processing condition may be changed to the substitutive processing condition before printing. In this case, when the detected error is an error (for example, “toner near end” or insufficient remaining paper) for which printing can be resumed in accordance with the print processing condition set in advance, the printing may not configured to be suspended. In this case, by setting a substitutive process for an error caused by the same reason (for example, “toner end” or “designated paper running out”) for which printing cannot be resumed, it becomes possible to resume printing in accordance with a substitutive process condition with the error dealt with.

### E2. Modified Example 2

In the above-described embodiments, the fist, second, and third embodiments are applied to different printers, but the first, second, and third embodiments may be applied to the same printer. In this case, the inquiry of the substitutive process to be applied of the user using the client, for example, is performed when the error cannot be dealt with by the substitutive process set based on the substitutive process configuration information AP included in the job data.

What is claimed is:

1. A printing device configured to print on the basis of a given print job, the printing device comprising:
an error detector configured to detect an error indicating the possibility that printing of the print job will not be completed under a printing condition that is set for the print job; and
a printing condition changing section configured to change the printing condition of the print job for completing the printing in a case where the error detector detects an error,
wherein the printing condition changing section changes the printing condition of the print job on the basis of the type of the error detected by the error detector and a substitutive printing condition set for the print job corresponding to the type of the error for dealing with the error.

2. The printing device according to claim 1,
wherein the substitutive printing condition is set on the basis of data supplied to the printing device at a time when the print job is given to the printing device.

3. The printing device according to claim 1,
wherein the printing condition changing section acquires the substitutive printing condition at a time when the error detected by the error detector is an error in printing and changes the printing condition of the print job on the basis of the substitutive printing condition that has been acquired.

4. The printing device according to claim 1,
wherein a plurality of the substitutive printing conditions can be set for each type of error, and
wherein the printing condition changing section is configured to select one of the substitutive printing conditions to be applied for changing the printing condition on the basis of priority levels assigned respectively to the substitutive printing conditions when the plurality of the substitutive printing conditions are set for each type of error.

5. The printing device according to claim 1,
wherein printing is performed under a printing condition that is set before the printing condition is changed by the printing condition changing section when the error detected by the error detector is dealt with.

6. A method of controlling a printing device that is configured to perform printing on the basis of a given print job, the method comprising:
(a) detecting an error indicating the possibility that printing of the print job will not be completed under a printing condition that is set for the print job; and
(b) changing the printing condition of the print job for completing the printing in a case where an error is detected in (a),
wherein the printing condition of the print job is changed on the basis of the type of error detected in (a) and a substitutive printing condition set for the print job corresponding to the type of error for dealing with the error in (b).
